(19) United States
(12) Patent Application Publication
(10) Pub. No.: US 2011/0298708 A1
(43) Pub. Date: Dec. 8, 2011

(54) Virtual Touch Interface

(75) Inventors: Feng-Hsiung Hsu, Cupertino, CA (US); Chunhui Zhang, Beijing (CN)

(73) Assignee: MICROSOFT CORPORATION, Redmond, WA (US)

(21) Appl. No.: 12/795,024

(22) Filed: Jun. 7, 2010

(51) Int. Cl. G09G 5/08

(52) U.S. Cl. 345/158

(57) ABSTRACT

A user may issue commands to a computing device by moving a pointer within a light field. Sensors may capture light reflected from the moving pointer. A virtual touch engine may analyze the reflected light captured as light portions in a sequence of images by the sensors to issue a command to a computing device in response to the movements. Analyzing the sequence of images may include finding the light portions in the sequence of images, determining a size of the light portions, and determining a location of the light portions.

### BACKGROUND

In traditional computing environments, users typically use a keyboard and mouse to control and interact with a computer. For example, a user would traditionally move a mouse to navigate a cursor displayed by a computer on a monitor. The user may additionally use the mouse to issue a limited number of simple commands to the computer (e.g., single-click and drag to highlight an item, double-click to open the item, right-click to access a menu of commands).

Today, computing users seek more intuitive, efficient, and powerful ways to issue commands to computers. Some devices, such as touch pads, touch panels (e.g., touch-enabled monitors, etc.), and wearable devices (e.g., motion sensor gloves) have expanded ways in which users interact with computers. In general, the touch pad is a navigation sensor located adjacent to a keyboard. Instead of using the traditional mouse to control a cursor, the user may physically touch (engage) the touch pad and slide her finger around the touch pad to control the cursor. Although the touch pad may be used in lieu of a mouse to control a computer, the touch pad may undesirably take up a significant amount of space on the keyboard such as when implemented in a laptop setting.

The touch panel has also expanded ways in which users issue commands to computers. In general, the touch panel combines a display with a built-in touch interface so that the user can issue commands to the computer by physically touching the screen. Although the touch panel is generally responsive to a wider range of operations than the touch pad (e.g., zooming, scrolling, etc.), the touch panel is susceptible to touch smears which can undesirable inhibit the display quality of the screen. In addition, the touch panel may be uncomfortable and tiresome for a user to operate for extended periods since the user may have to hold her arm up the screen.

Wearable devices are another example of a device which has expanded the ways in which users issue commands to computers. Generally, the motion sensor glove enables a user to use her hand as a natural interface device. Various sensors positioned on the glove detect hand motion. The motion is then translated as an input command to the computer. Since the motion sensor glove requires a plurality of optimally placed sensors, the device may undesirably be expensive and cumbersome for the user.

### SUMMARY

A virtual touch interface enhances a user's interactive experience within an intelligent environment such as a computing environment. The user may issue commands (e.g., moving a cursor, selecting an object, zooming, scrolling, dragging, inserting objects, selecting a desired input element from a list of displayed input elements, etc.) to a computing device by naturally moving a pointer (e.g., a finger, pen, etc.) within a light field projected by a light source proximate the user. Light reflected from the pointer is captured by various sensors as a sequence of images. The reflected light captured in the sequence of images may be analyzed to track the movement of the pointer. The tracked movement may then be analyzed to issue the command to the computing device.

The virtual touch interface may be implemented in various environments. For instance, the virtual touch interface may be used with a desktop computer, a laptop computer, or a mobile device to enable a user to issue commands to the computing device.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative virtual touch interface enabling a user to issue commands to a computing device via a light field.

FIG. 2 is a schematic diagram of an illustrative environment that includes a virtual touch engine to issue commands.

FIG. 3 is a flow diagram of an illustrative process of issuing commands using the virtual touch interface.

FIG. 4a is an exemplary virtual interface environment depicted to illustrate capturing a moving pointer.

FIG. 4b is an exemplary virtual interface environment depicted to illustrate locating a moving pointer within captured images.

FIG. 5 is a flow diagram of an illustrative process of analyzing an input capturing reflections from a moving pointer within a light field.

FIG. 6 is an illustrative a multi-touch command issued by a user to a computing device via the virtual touch interface.

### DETAILED DESCRIPTION

### Overview

Today's computing users seek intuitive, efficient, and powerful ways to interact with computing devices in order to enhance their overall computing experiences. A virtual touch interface may enhance user's general computing experience. When interacting with the virtual touch interface, a user may move a pointer within a light field to issue commands to a computing device. As used herein, “pointer(s)” are any object able to reflect light such as one or more fingers, a pen, pencil, reflector, etc. Various sensors capture light as it reflects from the pointer as a sequence of images. The images are then analyzed to issue commands. As used herein, “commands” are any commands issuable to a computing device such as moving a cursor, selecting an object, zooming, scrolling, rotating, dragging, inserting objects, selecting a desired input element from a list of displayed input elements, etc.

The process and systems described herein may be implemented in a number of ways. Example implementations are provided below with reference to the following figures.

### Illustrative Environment

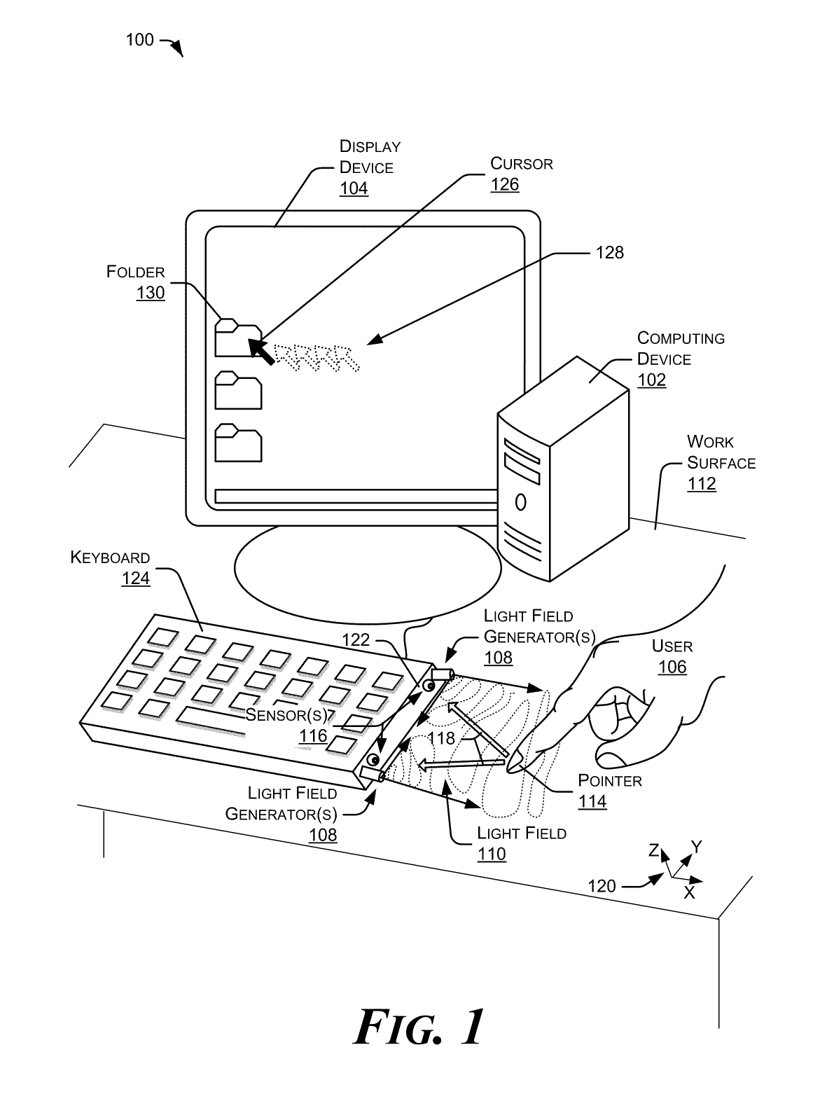

FIG. 1 is an illustrative virtual touch interface environment 100. The environment 100 may include a computing device 102 which may be connected to a network. The computing device may include a display device 104 such as a monitor to render video imagery to a user 106. One or more light field generator(s) 108 may each generate a light field 110 to be used by in lieu of a mouse or other computing device interface (touch pads, touch panels, wearable devices, etc.). The light field 110 may be planar in shape and be positioned parallel to a work surface 112 such as a desktop. In some embodiments, an aspect ratio of the light field 110 is substantially equivalent to an aspect ratio of the display device 104.

FIG. 1 illustrates the light field 110 generated by two light field generators to cover a portion of the work surface 112. In some embodiments, the light field may cover the entire work surface 112. The light field generator(s) 108 may be implemented as any number of devices operable to emit either visible light or another form of non-visible electromagnetic radiation such as an infrared light source, an infrared laser diode, and/or a photodiode. For Instance, the light field generator(s) 108 may be implemented as two separate infrared Light Emitting Diodes (LEDs), each LED equipped with a cylindrical lens to emit a non-visible form of electromagnetic radiation, such as infrared light, into two light fields. In some instances, the two lights fields are parallel to one another. For example, the light field may include a first light field positioned at a first height relative to the work surface and a second light field positioned at a second height relative to the work surface. In the event that the light field is generated by two light field generator(s) 108, each light field generator may be independently operable. For example, each light field generator may be turned on or off independently.

The user 106 may move a pointer 114 (e.g., a finger, multiple fingers, pen, pencil, etc.) within the light field 110 to issue commands to the computing device 102. When the user 106 moves the pointer 114 within the light field 110, light may reflect off of the pointer 114 and reflect towards one or more sensor(s) 116 as illustrated by arrows 118. The sensor(s) 116 may capture the reflected light 118 as it reflects from the pointer 114. In some embodiments, the sensor(s) 116 are tilted with respect to the light field 110 and are positioned proximate the light field generator(s) 108 to maximize a captured intensity of the reflected light 118. For instance, the sensor(s) 116 may be implemented such that a focal point of the sensors is centered at a desired position such as two-thirds of a longest distance to be sensed. In some embodiments, the sensor(s) 116 have a field of view that covers the entire work surface 112.

The sensor(s) 116 may capture the reflected light 118 as a sequence of images. In some embodiments, the sensor(s) 116 are implemented as infrared cameras operable to capture infrared light. Alternatively, the sensor(s) 116 may be any device operable to capture reflected light (visible or invisible) such as any combination of cameras, scanning laser diodes, and/or ultrasound transducers.

After the sensor(s) 116 capture the reflected light 118 as a sequence of images, the sequence of images may be analyzed to track a movement of the pointer 114. In some embodiments, two cameras may capture the reflected light 118 in order to determine a vertical position, a lateral position, and/or an approach position of the pointer. As illustrated in FIG. 1, the vertical position may be defined along the Z-axis of a coordinate system 120 (i.e., distance perpendicular to the light field 110 plane, towards or away from the work surface 112); the lateral position may be defined along the Y-axis of the coordinate system 120 (i.e., distance within the light field 110 plane, parallel to an end side 122 of a keyboard 124); and the approach position may be defined along the X-axis of the coordinate system 120 (i.e., distance within the light field 110 plane, towards or away from the light field generator(s) 108).

For example, if the user 106 moves her finger along the X-axis within the light field 110 towards the sensor(s) 116, then the sensor(s) 116 may capture light reflected from the finger as a sequence of images. Reflected light captured in each image of the sequence of images may then be analyzed to track the movement of the finger as a decreasing approach positioning while the vertical positioning and the lateral positioning remain unchanged. This tracked movement (i.e., approach movement) may be translated as a move cursor command. Accordingly, a cursor 126 displayed on the display device 104 may be moved in a respective trajectory 128 to the left on the display device towards a folder 130. Similarly, if the user 106 moves her finger in the Y-direction towards the display device 104, then the lateral movement may be translated as a move cursor command to move the cursor 126 up on the display device 104.

The virtual touch interface environment 100 may be used to issue a variety of commands (single or multi-touch) to computing device 102. Some examples of issuable commands may include moving the pointer 114 to issue a cursor command, moving the pointer up and down in the light field 110 to issue a click/pressing event, swirling the pointer in a clock-wise circle to issue a browse-down command (scroll down, “forward” navigation command, etc.), swirling the pointer 114 in a counter-clock-wise circle to issue a browse-up command (scroll up, “back” navigation command, etc.), moving two fingers together or apart to issue a zoom-in/zoom-out command, rotating two fingers to issue a rotate object command, bringing two fingers together in a pinching manner to issue a select (grab) and drag command, tracing characters with the pointer 114 to issue a object input (e.g., typing) command, etc. These examples are only illustrative commands that may be issued via the virtual touch interface environment 100 of FIG. 1. In other embodiments, the touch interface environment 100 may be used to issue any single or multi-touch event to the computing device 102.

Although FIG. 1 illustrates the sensor(s) 116 as connected to a keyboard 124, it should be appreciated that the sensor(s) may be implemented and/or configured in any manner. For example, the light field generator(s) 108 and/or sensor(s) 116 may be implemented as an integrated component of the keyboard 124 or they may be mounted to the keyboard as a peripheral accessory. Alternatively, the sensor(s) 116 may be implemented as a stand-alone device located proximate a desirable location for the light field 110 and in communication (wired or wirelessly) with the computing device 102. For instance, the sensor(s) 116 may be located anywhere as long as a path (i.e., line of sight) between the sensor(s) 116 and the light field 110 is not occluded by other objects.

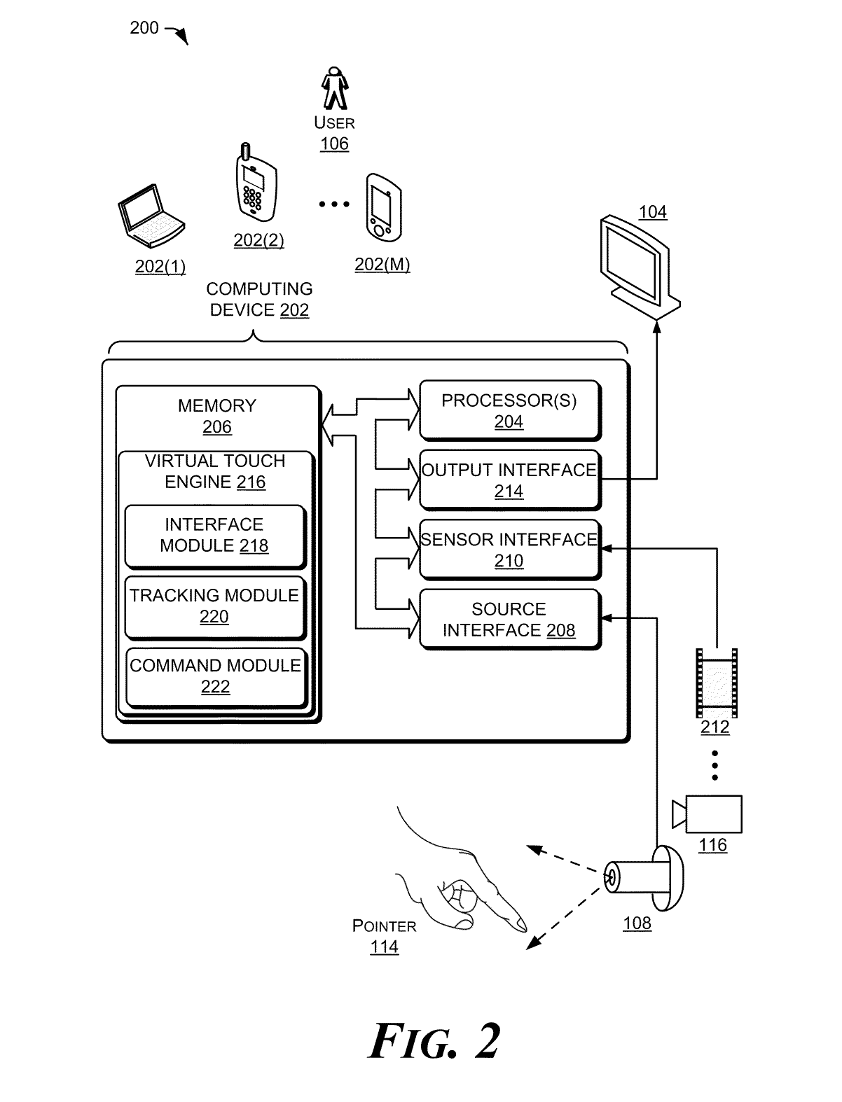

FIG. 2 illustrates an example of a computing system 200 in which a virtual touch interface may be implemented to issue commands to a computing device 102. The computing system 200 is only one example of a computing environment and is not intended to suggest any limitation as to the scope of use or functionality of the virtual touch interface.

The computing system 200 includes a computing device 202 capable of generating a light field, capturing reflections from pointers as they move within the light field, analyzing the captured reflections, and issuing commands based on the analysis. The computing device 202 may include, without limitation a personal computer 202(1), a mobile telephone 202(2) (including a smart phone), a personal digital assistant (PDA) 202(M). Other computing devices are also contemplated such as a television, a set top box, a gaming console, and other electronic devices that issue commands in response to sensing movements within a light field 110. Each of the computing devices 202 may include one or more processors 204 and memory 206.

As noted above, the computing system 200 issues commands based on analyzing captured reflections from a moving pointer. For example, the computing system 200 may be used to control a cursor displayed on the display device 104 in response to a moving pointer within the light field 110.

In some embodiments, the computing system 200 may include the light field generator(s) 108 (e.g., infrared light source, infrared laser diode, and/or photodiode), which may emit light to generate the light field 110 via a field generator interface 208. As discussed above with reference to FIG. 1, the light field generator(s) 108 may be an infrared Light Emitting Diode (LED) bar to emit a non-visible form of electromagnetic radiation such as infrared light. In the event that the light field generator(s) 108 is an LED bar, the field generator interface 208 may control the LED bar to generate an infrared light field invisible to the user 106.

In some embodiments, the computing system 200 may include one or more sensor(s) 116 (e.g., scanning laser diodes, ultrasound transducers, and/or cameras) to capture light reflected from a pointer via a sensor interface 210. In some embodiments, the sensor(s) 116 may capture the reflected light as a sequence of images 212.

In some embodiments, the computing system 200 may include an output interface 214 to control a display connected to the computing system 200. For instance, the output interface 214 may control a cursor displayed on the display device 104. The display device 104 may be a stand alone unit or may be incorporated into the computing device 202 such as in the case of the laptop computer, mobile telephone, tablet computer, etc.

The memory 206 may include applications, modules, and/or data. In some embodiments, the memory is one or more of system memory (i.e., read only memory (ROM), random access memory (RAM)), non-removable memory (i.e., hard disk drive), and/or removable memory (i.e., magnetic disk drive, optical disk drive). Various computer storage media storing computer readable instructions, data structures, program modules and other data for the computing device 202 may be included in the memory 206. In some implementations, the memory 206 may include a virtual touch engine 216 to analyze the sequence of images 212 capturing light reflected from the moving pointer 114.

The virtual touch engine 216 may include an interface module 218, a tracking module 220 and a command module 222. Collectively, the modules may perform various operations to issue commands based on analyzing reflected light captured by the sensor(s) 116. In general, the interface module 218 generates the light field 110, the tracking module 220 captures and analyzes the sequence of images 212, and the command module 222 issues commands based on the analysis. Additional reference will be made to these modules in the following sections.

### Illustrative Operation

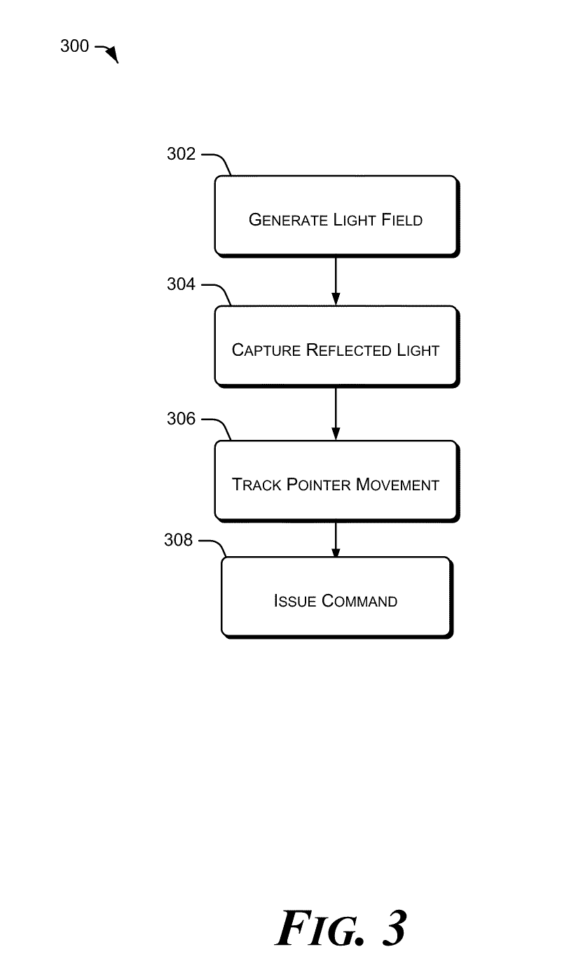

FIG. 3 is a flow diagram of an illustrative process 300 of issuing commands based on analyzing captured reflections from a moving pointer within a light field. The process 300 may be performed by the virtual touch engine 216 and is discussed with reference to FIGS. 1 and 2.

The process 300 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 300, shall be interpreted accordingly.

At 302, the field generator interface 208 controls the light field generator(s) 108 (e.g., LED bar) to generate the light field 110. In some embodiments, the field generator interface 208 directs the light field generator(s) 108 to project the light field parallel to a work surface such as a desk. The light field 110 may be proximate a keyboard such that a user can issue commands via the keyboard and/or the light field without having to move positions.

At 304, the sensor interface 210 controls one or more sensor(s) 116 (e.g., infrared cameras) to capture light reflected from a pointer within the light field 110 as a sequence of images 212. For example, if the user 106 moves the pointer 114 in the light field 110 to control a cursor, then the sensor(s) 116 may capture light reflected from the moving pointer 114 within the light field. In some embodiments, the pointer 114 may be a user's finger such that the sensor interface 210 relies on a natural reflectivity of the user's skin to capture the reflected light. In some instances, the user 106 may increase the reflectivity of their finger by attaching a reflective device to the finger. Alternatively, the pointer 114 may be any physical object that includes a reflective item such as a bar code. It should be appreciated that the sensor(s) may capture either visible or non-visible light.

At 306, the tracking module 220 analyzes the reflected light captured in the sequence of images 212 to track a movement of the pointer 114. The tracking module may track the movement of the pointer at 306 by determining a location of the reflected light captured in each image of the sequence of images 212. In some embodiments, each image of the sequence of images is analyzed as a two dimensional image at 306 to determine a location of the reflected light. The location of the reflected light may be determined in terms of a vertical position (i.e., position along the Z-axis), a lateral position (i.e., position along the Y-axis), and/or approach position (i.e., position along the X-axis).

At 308, the command module 222 issues a command based on the analysis performed at 306. For instance, if the tracking module 220 tracks a moving pointer as an approach movement based on analyzing reflected light captured in the sequence of images 212 at 306, then the command module may issue a move cursor command at 308 to move a cursor displayed on a display device.

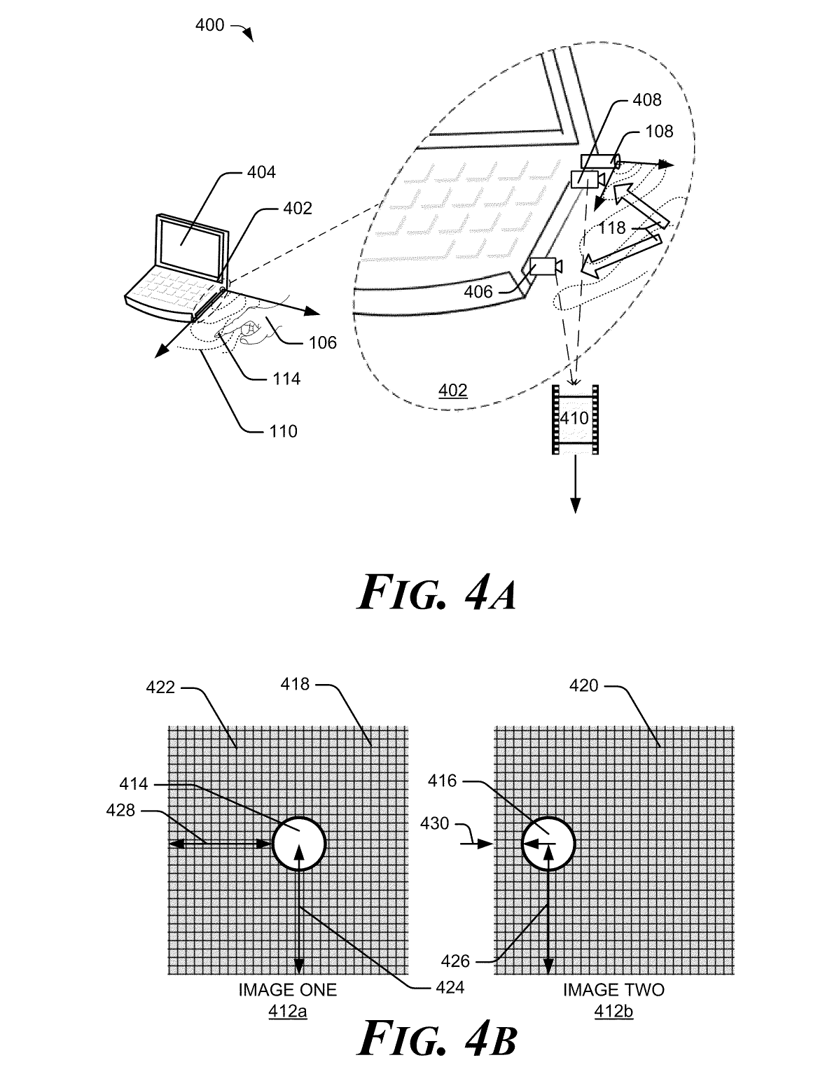

FIG. 4a illustrates an exemplary environment 400 of tracking a movement of a pointer by analyzing a sequence of images that capture light reflected from the pointer. The exemplary environment 400 illustrates a virtual touch device integrated into a side 402 of laptop computer 404 and operable to track a movement of a pointer by analyzing a sequence of images that capture light reflected from the pointer. Although FIG. 4a illustrates the virtual touch device integrated into the side 402 of the laptop computer 404, the virtual touch device may be integrated into any computing device capable of generating a light field, capturing reflections from pointers as they move within the light field, analyzing the captured reflections, and issuing commands based on the analysis such as a desktop computer, a mobile phone, and/or a PDA. In some embodiments, the virtual touch device is build into the computing device. Alternatively, the virtual touch device may be mounted to the computing device as a peripheral accessory. For instance, the virtual touch device may be communicatively coupled to the computing device via a Universal Serial Bus (USB) port.

As the user 106 moves the pointer 114 within the light field 110, the light in the light field may reflect off of the pointer 114 and reflect towards sensor one 406 and sensor two 408 as illustrated by arrows 118. Sensor one 406 and sensor two 408 may both capture the reflected light 118 as a sequence of images 410.

FIG. 4b shows illustrative images of the sequence of images 410 of FIG. 4a. Image one 412a and image two 412b represent two images of the sequence of images 410 captured from sensor one 406 and sensor two 408 respectively. Light portions 414 and 416 represent areas where the reflected light 118 (i.e., light reflected off of the pointer 114) is captured by sensors 406 and 408 respectively. The darker portions 418, 420 of the images 412 represent areas where the sensors 406, 408 capture ambient light or reflections from less reflective and/or more distant objects.

The images 412 include a number of pixels 422 which may be used to determine a location of the pointer 114. For instance, a vertical position (i.e., position along the Z-axis) of the pointer 114 may be determined based on a vertical pixel distance 424, 426 of the light portions 414, 416. The vertical position may be calculated from either the vertical pixel distance 424 of image one 412a or the vertical pixel distance 426 of image two 412b. Alternatively, both the vertical pixel distances 424, 426 of image one 412a and image two 412b may be used to calculate a vertical position of the pointer. It should be appreciated that other techniques may be used to determine the vertical position. For instance, the virtual touch interface may include more than one parallel light fields positioned one on top of the other and separated by a pre-determined distance. In such instances, the vertical position may be determined based on the number of light fields that are penetrated by the pointer 114. The more touch fields that are penetrated, the greater the vertical position.

A lateral position (i.e., position along the Y-axis) of the pointer 114 may be determined based on a lateral pixel distance 428, 430 of the light portion. The lateral position may be calculated from either the lateral pixel distance 428 of image one 412a or the lateral pixel distance 430 of image two 412b. Alternatively, both the lateral pixel distances 428, 430 of image one 412a and image two 412b may be used to calculate the lateral position.

An approach position (i.e., position along the X-axis) may be triangulated based on the vertical pixel distance 424, 426 and the lateral pixel distance 428, 430 of images 412 since the two images are captured from two difference cameras (e.g., sensors 406, 408).

Although FIG. 4b illustrates the images 412 including a single light portion (i.e., sensors 406, 408 capture the light portions 414, 416 as light reflected from a single pointer), the images 412 may contain multiple light portions (i.e., sensors 406, 408 capture light reflected from multiple pointers within the light field). For example, if the user 106 issues a multi-touch event (e.g., zoom, rotate, etc.), then the images 412 may contain multiple light portions to represent that the sensors are capturing reflected light from multiple pointers within the light field 110.

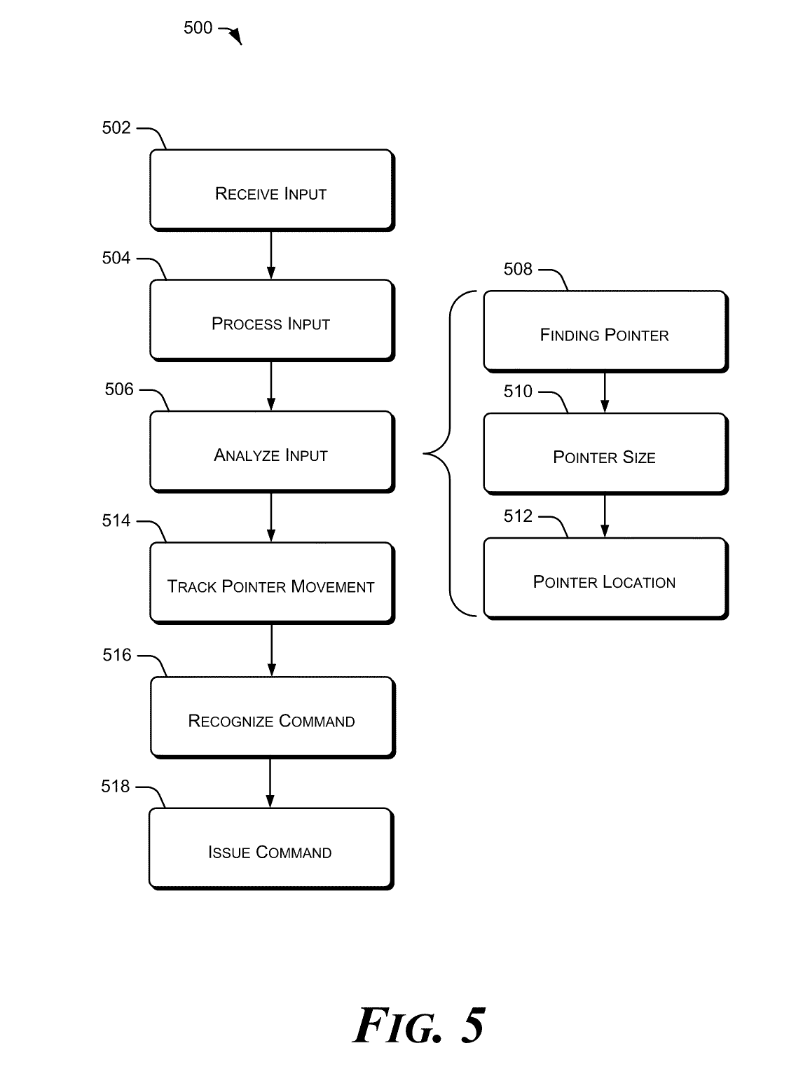

FIG. 5 is a flow diagram of an illustrative process 500 of analyzing an image input for one or more computing events. The process 500 may further describe the track pointer movement element discussed above (i.e., block 306 of FIG. 3). The order of operations of process 500 is not intended to be construed as a limitation.

At 502, the tracking module 220 receives an input. The input may be a sequence of images capturing light reflected from a moving pointer 114 as shown in FIG. 1. The reflected light may take the form of one or more light portions in the input as illustrated in FIG. 4b. The light portion captured in the input may represent a command issued to a computing device.

At 504, the tracking module 220 processes the input. In some embodiment, a Gaussian filter is applied to smooth images of the input. The tracking module 220 may additionally convert the input to a binary format at 504.

At 506, the tracking module 220 analyzes the input. Operations 508 through 512 provide various sub-operations for the tracking module 220 to analyze the input. For instance, analyzing the input may include finding one or more light portions in the input at 508, determining a size of the light portions at 510, and/or determining a location of the light portions at 512.

At 508, the tracking module 220 analyzes the input to find the light portions. Since the input may contain either a single light portion (e.g., user is issuing a single touch event) or the input may contain multiple light portions (e.g., user is issuing a multi-touch event), then the tracking module 220 may analyze the input to find one or more light portions at 508.

The tracking module 220 may utilize an edge-based detection technique to find the light portions at 508. For instance, the edge-based detection technique may analyze a color intensity gradient of the input to locate edges of the light portions since the difference in color intensity between the light portions and the darker portions is distinct. In the event that one or more portions of the light portions are hidden, the edge-based detection technique may use extrapolation techniques to find the light portions at 508.

At 510, the tracking module 220 may determine a size of the light portions. The size of the light portions may be useful in determining whether or not the user 106 is intending to issue a command. For example, in some instances the sensor(s) may capture light reflected from an object other than the pointer 114. In such instances, the tracking module 220 may exclude one or more of the light portions at 506 if a size of the light portions is outside a predetermined range of pointer sizes. The size of the light portions may additionally be used to determine the type of command that is being issued to the computing device. For example, if the size of the light portion is large (e.g., double a normal size of the light portion), then this may suggest that the user 106 is holding two fingers together such as pinching together the thumb and forefinger to issue a grab command.

At 512, the tracking module 220 determines the location of each of the light portions within the input. Determining the location of the light portions may include calculating a vertical pixel distance 424, 426 (i.e., distance perpendicular to the light field 110 plane, towards or away from the work surface), calculating a lateral pixel distance 428, 430 (i.e., distance within the light field 110 plane, parallel to an end side 122 of a keyboard 124), and/or triangulating an approach distance (i.e., distance within the light field 110 plane, towards or away from the light field generator) based on the vertical pixel distance and the lateral pixel distance of each of the light portions.

The tacking module 220 may track a movement of the pointer 114 at 514 based on the input analysis performed at 506. Once the location (e.g., vertical pixel distance, lateral pixel distance, and approach distance) are determined for various time based inputs, the tracking module 220 chronographically collects the location of each pointer as a function of time to track the movement of the pointer at 514.

At 516, the tracking module 220 translates the tracked movement as a command issued to a computing device. For example, if the approach distance of the pointer 114 is decreasing in each time sequenced input while the vertical pixel distance and lateral pixel distance remain constant, the tracking module 220 may track the movement of the pointer at 514 as a command to move a cursor to the left on the display device. In the event that the input contains multiple light portions, the tracking module 220 may translate the tracked movement as a multi-touch event (as zooming, rotating, etc.) at 516. For example, if two light portions are found at 508 and the two light portions are moving closer together, then the tracking module 220 may translate such tracked movement as a zoom-out command.

At 518, the command module 222 issues the command to the computing device. In some embodiments, the command module 222 may further provide feedback to the user at 518 in order to enhance the user's interactive experience. For example, feedback may include one or more of changing an appearance of an object, displaying a temporary window describing the issued command, and/or outputting a voice command describing the issued command.

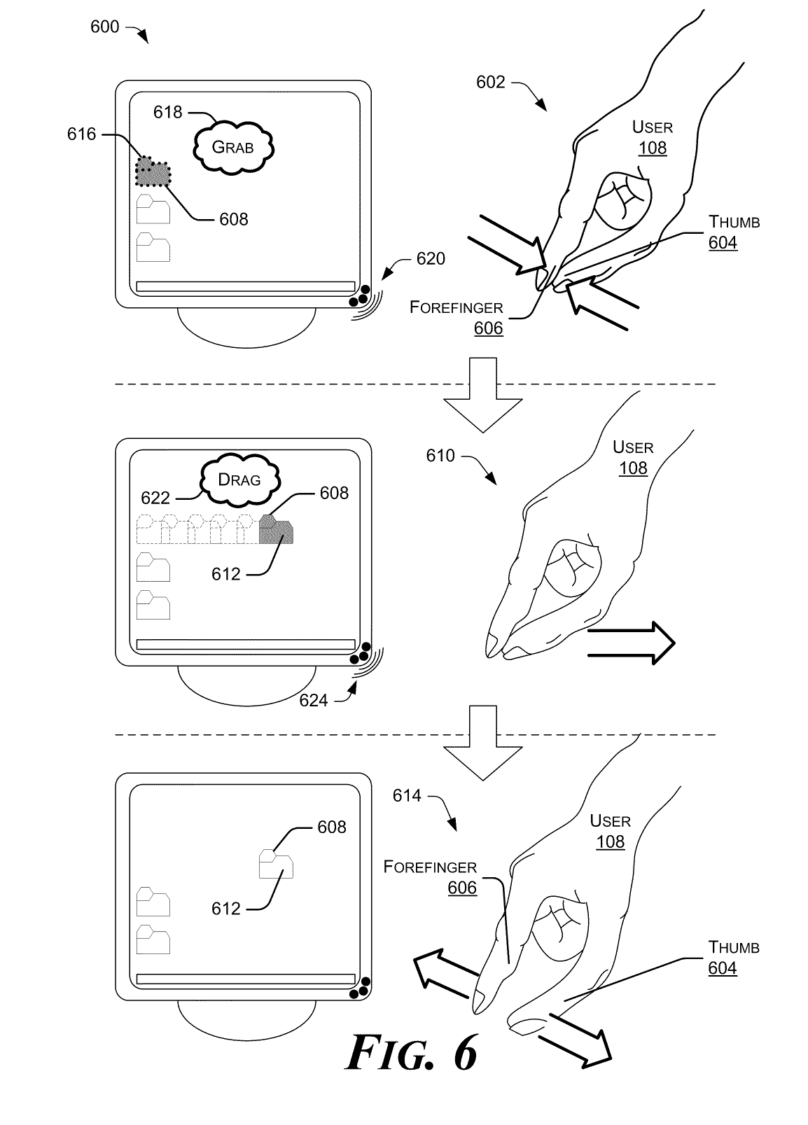

FIG. 6 illustrates some exemplary multi-touch commands 600 that may be issued to computing device. In accordance with various embodiments, the virtual touch interface may be used to issue single touch commands (e.g., move cursor, select object, browse up/down, navigate forward/back, etc.) or multi-touch commands (e.g., zoom, grab, drag, etc.). For example, the user may issue a grab command 602 by touching the thumb 604 and forefinger 606 together. In response to the grab command 602, a selected item such as folder 608 may respond as if it is being “grabbed” by the user 106. The user may then issue a drag command 610 by moving the thumb and finger within the light field to drag the folder 608 to a desired location 612. When the folder is at the desired location 612, the user may separate the thumb and forefinger to simulate a drop command 614. In response to the drop command 614, the folder may be placed at the desired location 612.

The multi-touch commands 600 also illustrate some examples of feedback may be provided to the user in order to enhance the user's interactive experience. For instance, feedback provided in response to the grab command 602 may include one or more of outlining the “grabbed” folder 608 with dashed lines 616, displaying a temporary window describing the command 618, and/or outputting a voice command describing the command 620. Additionally, feedback provided in response to the drag command 610 may include one or more of displaying a temporary window describing the command 622 and/or outputting a voice command describing the command 624.

### CONCLUSION

Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A computer-implemented method comprising:
emitting light from a source to generate a light field parallel to a work surface;
capturing light at one or more sensors positioned outside the light field as a sequence of images, the light reflected from a pointer positioned within the light field;
analyzing the reflected light captured in the sequence of images to track a movement of the pointer; and
analyzing the tracked movement to issue a command to a computing device.

2. The computer-implemented method as recited in claim 1, wherein the generating a virtual interface comprises generating an infrared field via one or more infrared light-emitting diode (LED) bars, an aspect ratio of the infrared field substantially equivalent to an aspect ratio of a display device of the computing device.

3. The computer-implemented method as recited in claim 1, wherein the generating a virtual interface comprises generating an infrared field via one or more infrared laser diodes.

4. The computer-implemented method as recited in claim 1, wherein the command is one of a zoom command, a navigate command, and a rotate command to manipulate a user interface via the computing device.

5. The computer-implemented method as recited in claim 1, wherein the analyzing the reflected light analyzes a color intensity gradient of each image of the sequence of images to locate an edge of one or more light portions within each image of the sequence of images.

6. The computer-implemented method as recited in claim 1, wherein the one or more sensors include one or more infrared cameras.

7. The computer-implemented method as recited in claim 1, wherein the analyzing the reflected light in the sequence of images includes:
determining a vertical pixel location of the pointer for each image of the sequence of images;
determining a lateral pixel location of the pointer for each image of the sequence of images; and
triangulating an approach location based on the vertical pixel location and the lateral pixel location for each image of the sequence of images.

8. One or more computer-readable media storing computer-executable instructions that, when executed on one or more processors, causes the one or more processors to perform acts comprising:
receiving a sequence of images that capture a movement of a pointer in a light field as one or more light portions, the light portions indicative of a command issued to a computing device;
finding the one or more light portions in each image of the sequence of images;
determining a size of each of the one or more light portions in each image of the sequence of images;
determining a location of each of the one or more light portions in each image of the sequence of images to track the movement of the pointer;
translating the tracked movement to the command issued to the computing device; and
issuing the command to the computing device.

9. The one or more computer-readable media as recited in claim 8, wherein the determining the location of each of the one or more light portions in each image of the sequence of images further includes:
calculating a vertical pixel distance of each of the one or more light portions;
calculating a lateral pixel distance of each of the one or more light portions; and
triangulating an approach distance based on the vertical pixel distance and the lateral pixel distance.

10. The one or more computer-readable media as recited in claim 8, wherein the finding the one or more light portions utilizes an edge-based detection technique to find the one or more light portions.

11. The one or more computer-readable media as recited in claim 10, wherein the edge-based detection technique analyzes a color intensity gradient within each image of the sequence of images to find the one or more light portions.

12. The one or more computer-readable media as recited in claim 8, further comprising providing feedback based on the issued command, the feedback being one or more of changing an appearance of an object, displaying a temporary window describing the issued command, and outputting a voice command describing the issued command.

13. The one or more computer-readable media as recited in claim 8, further comprising omitting one or more light portions having the size outside a predetermined range of light portion sizes.

14. The one or more computer-readable media as recited in claim 8, wherein the issuing the command to the computing device includes issuing a multi-touch command to the computing device.

15. The one or more computer-readable media as recited in claim 14, wherein the issuing the multi-touch command to the computing device includes issuing one of a zooming and rotating command to the computing device.

16. A virtual touch interface system comprising:
one or more processors; and
memory to store modules executable by the one or more processors, the modules comprising:
an interface module to generate an infrared light field;
a tracking module to analyze a moving pointer within a light field captured in a sequence of images by a sensor positioned outside the light field, the tracking module analyzing the moving pointer to: (1) locate one or more light portions in each image of the sequence of images, (2) track a movement of the moving pointer based on the located one or more light portions, and (3) translate the tracked movement to a command; and
a command module to issue the command to the computing device.

17. The virtual touch interface system as recited in claim 16, wherein the tracking module further determines a size of each of the one or more light portions.

18. The method as recited in claim 16, wherein the locating one or more light portions locates the one or more light portions as a vertical pixel distance, a lateral pixel distance, and an approach distance.

19. The method as recited in claim 16, wherein the command module issues a multi-touch command to the computing device.

20. The method as recited in claim 16, wherein the command module further provides feedback based on the issued command, the feedback being one or more of changing an appearance of an object, displaying a temporary window describing the issued command, and outputting a voice command describing the issued command.
